(19) United States
(12) Patent Application Publication
(10) Pub. No.: US 2011/0011159 A1
(43) Pub. Date: Jan. 20, 2011

(54) Device for determining the oxygen content of a gas

(75) Inventors: Jörg Müller, Buchholz (DE); Stefan Vonderschmidt, Hamburg (DE)

Correspondence Address: KUSNER & JAFFE;HIGHLAND PLACE SUITE 310, 6151 WILSON MILLS ROAD, HIGHLAND HEIGHTS, OH, 44143, US

(73) Assignee: M & C Tech Group Germany

(21) Appl. No.: 12/835,813

(22) Filed: Jul. 14, 2010

(30) Foreign Application Priority Data
Jul. 16, 2009 (DE) 10 2009 033 420.3

(51) Int. Cl. G01N 27/74

(52) U.S. Cl. 73/25.02

(57) ABSTRACT

The device for measuring the oxygen content in a gas mixture comprises three flow channels, a main channel, a measuring channel and a reference channel, over which the gas stream is distributed. By using a non-homogeneous magnetic field produced by a magnet, the gas flow is deflected into the measuring channel as a function of oxygen content; at the same time, the flow in the reference channel is reduced. The oxygen content of the gas is determined by means of a flow measurement of the volume flow of gas in the measuring or reference channel by means of resistance thermometers.

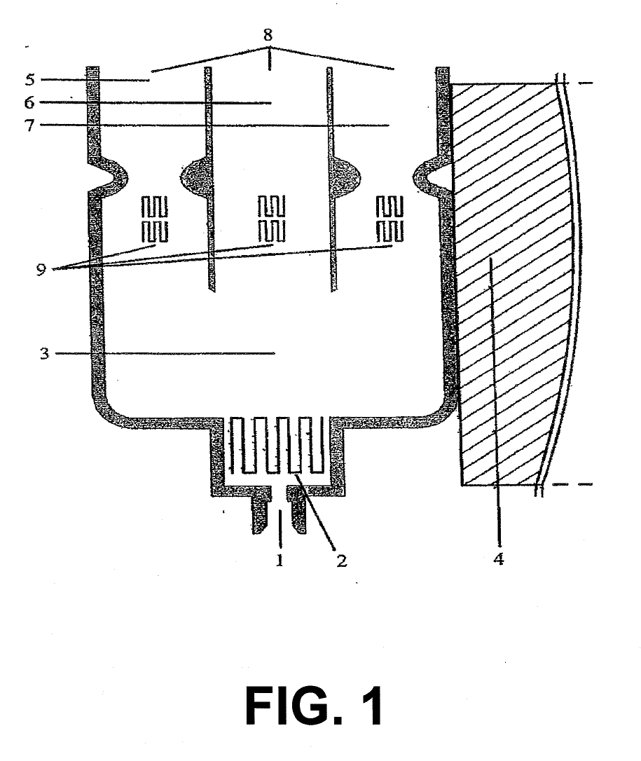

### FIELD OF THE INVENTION

The invention relates to a device for determining the oxygen content of a gas, comprising a gas inlet, a gas outlet and a measuring zone arranged therebetween.

### BACKGROUND OF THE INVENTION

Sensors for determining the oxygen content of gases can, for example, be based on the principle of electrochemical reactions, solid state ionic conduction and paramagnetism.

The latter sensor is based on the paramagnetic property of oxygen. Paramagnetic materials are drawn into a non-homogenous magnetic field, while diamagnetic materials are repelled from a magnetic field. The advantages of the paramagnetic method for oxygen measurement over other methods are that no materials are consumed, no chemical reactions occur and the sensor is thus stable over long periods of time. Oxygen sensors based on the paramagnetic properties of oxygen are known and are manufactured and used industrially. An example in this regard is oxygen measurement using a mirror system. A freely pivotably mounted dumbbell with diamagnetic dumbbell bodies is deflected from its rest position by an oxygen-containing gas. That deflection is measured using a laser, a mirror and a photodiode and is a measure of the oxygen concentration in the gas. The disadvantages of that system are its size and its susceptibility to shocks.

### SUMMARY OF THE INVENTION

The object of the invention is to provide a sensitive oxygen sensor based on paramagnetism which does not have any moving parts and has small dimensions.

The solution of the invention comprises in providing that the measuring zone comprises three channels arranged side by side in the form of a main channel, a measuring channel arranged on one side of the main channel and a reference channel arranged on the other side of the main channel, a magnet arranged on the side of the measuring channel opposite to the main channel and having a non-homogeneous magnetic field, and flow sensors in the measuring channel and reference channel.

In the case of an oxygen-free gas, the main part of the gas flow moves between the gas inlet and the gas outlet through the main channel, while only a little gas flows through the measuring channel and the reference channel. In the case of an oxygen-containing gas, the gas flow is deflected in the non-homogeneous magnetic field of the magnet in a manner such that a larger portion of the gas flows through the measuring channel and a smaller portion flows through the reference channel. These flows in the measuring channel and reference channel are measured by the flow sensors and the oxygen content can be determined on the basis of these measurements.

In an advantageous embodiment, a flow sensor is also provided in the main channel. In this regard, in particular, the flow sensors are constituted by resistance thermometers. These work on the principle that at different flow rates, the resistances are cooled to different extents and thus their resistance varies. The advantage of these resistance thermometers is thus that they can be very small in construction.

Thus, the device of the invention can also be produced with small dimensions, more particularly using microsystem technology methods; however, its sensitivity is high, with industrial usability. The advantages of a paramagnetic oxygen sensor produced using microsystem technology, in addition to the general advantages of paramagnetic sensors, are that they are well suited to miniaturization and benefit from the good reproducibility and low manufacturing costs conditional upon batch processes.

In an advantageous embodiment, the device is formed as a glass-silicon-glass sandwich. On a glass substrate comprising the structures for the resistance thermometer or thermoanemometer, a layer of silicon comprising the channel structures and a further glass layer as a cover for the channel structures are applied.

In a further advantageous embodiment, at least partially the device is made of polymers.

Advantageously, thin film platinum thermometers are used as the resistance thermometer or thermoanemometer. They are especially sensitive when, in an advantageous embodiment, the thin film platinum thermometer is undercut using a wet chemical technique since in this manner, the thin platinum film reacts especially sensitively to variations in the flow rate. In a particularly advantageous embodiment, the resistance thermometers are arranged in the centre of the channels both in the width direction and in the height direction, as the flow rate is highest there.

Advantageously, the resistance thermometer is connected to a measuring bridge.

In an economic embodiment, the magnet is a permanent magnet which is advantageously formed from rare-earth elements. In another embodiment, an electromagnet is used. This has the advantage that its energizing current can advantageously be modulated. The corresponding modulation of the flow rates then means that the oxygen content can be measured in a particularly precise manner. Instead of modulating the energizing current of the electromagnet or in addition thereto, a heating device can be arranged between the gas inlet and the measuring zone to provide thermal modulation of the paramagnetic properties of the gas. This exploits the fact that paramagnetism is temperature-dependent and susceptibility decreases with increasing temperature.

In one embodiment, the gas is not only divided into three channels from the gas inlet, but the three channels behind the resistance thermometers in the direction of flow are connected together and discharge into a common gas outlet. In another embodiment, the gas is allowed to flow out freely from the ends of the channels.

The channels may not lie exactly adjacent to each other. As an example, the channels may also be arranged in bundles.

In accordance with one embodiment, no reference channel is provided. In this case, the oxygen content is determined absolutely as a function of the flow values measured at the flow sensor in the measuring channel.

The magnet for producing the non-homogeneous magnetic field may not be or may not be only arranged on the side of the measuring channel opposite to the main channel. As an example, the magnet may also be arranged around the measuring channel or over and/or under the measuring channel.

In general, the magnet can be arranged so that a non-homogeneous magnetic field is produced in the measuring channel or it may be constructed so that it can produce a non-homogeneous magnetic field therein.

In accordance with one embodiment of the invention, the measuring zone does not have exactly three channels. For example, the measuring zone may be provided with any number of channels, for example only one or two channels, or optionally four or more channels. The measuring zone is thus manufactured so that the variation in flow or deflection of a gas brought about by its oxygen content encountering the non-homogeneous magnetic field as it flows through the measuring zone can be measured by flow sensors. The remarks made above in respect of a measuring zone with three channels are valid in this case as well.

In accordance with one embodiment, it may also be provided that the measuring zone comprises only a single channel. In this embodiment, for example, this channel may have a major flow zone through which the major portion of an oxygen-free gas flows, as well as one or more minor flow zones through which only a smaller portion of an oxygen-free gas flows. Further, a magnet for producing a non-homogeneous magnetic field in the zone of a first minor flow zone and a flow sensor arranged in this first minor flow zone may be provided. As mentioned above, in the case of an oxygen-containing gas, the gas flow in the non-homogeneous magnetic field of the magnet is deflected such that a larger portion of the gas flows through the first minor flow zone, and thus the oxygen content can be measured by the flow sensor. In accordance with a further development of this inventive concept, in this embodiment of the measuring zone, a second minor flow zone may be provided which preferably is on the side of the major flow zone opposite to that of the first minor flow zone. This second minor flow zone can also have a flow sensor. An essential advantage of this embodiment with only a single channel is its particularly simple construction.

In the embodiment described above with only one single channel, the first minor flow zone essentially corresponds to the measuring channel described above and the second minor flow zone essentially corresponds to the reference channel described above. The remarks made above in respect of the measuring channel and reference channel are thus valid for the first and second minor flow zone respectively.

### BRIEF DESCRIPTION OF THE DRAWING

The invention will now be described with the assistance of an advantageous embodiment made with reference to the accompanying drawing, which shows an example of the structure of a device in accordance with the invention, in plan view.

### DETAILED DESCRIPTION OF THE INVENTION

The gas to be investigated is guided from a gas inlet 1 over a heating coil 2 to modulate the paramagnetic properties of the gas into a zone 3 in which it can be deflected by a laterally arranged magnet 4, preferably produced from rare-earth elements. Because of its lateral arrangement, the dimensions of the magnet are not limited by the dimensions of the microsystem and thus it can have any size or strength. As an alternative to a permanent magnet, it is also possible to produce the magnetic field using an electromagnet and optionally to modulate it.

Adjacent to this zone, the test gas flows through three channels, a main channel 6, a measuring channel 7 and a reference channel 5 and can then leave the sensor via a gas outlet 8. Inside the measuring channel 7 and the reference channel 5, the flow rate of the gas in these channels is measured using thermoanemometers 9. Measuring the flow rate in the main channel 6 using a further thermoanemometer 9 means that the total volume flow can be determined.

The sensor is, for example, produced from three stacked substrates, preferably one of glass comprising the structures for the thermoanemometer, one of silicon comprising the channel structures and a further one of glass acting as a cover for the channel structures. Other microsystem technology processes, however, in particular those that use polymers to form such (part) structures, are also suitable.

To construct it, firstly platinum strip conductors are constructed on a glass wafer. In order to be able to measure the flow rate in a sensitive manner using these platinum structures, they are, for example, undercut in a wet chemical process in order to form free-standing platinum filaments.

The channel structures are etched into the silicon substrate, preferably using an ASE (Advanced Silicon Etching) process, and the two substrates are bonded by anodic bonding. Next, the channel structures are etched completely through the silicon substrate. Subsequently, this composite is attached to the second glass substrate in order to produce closed channel structures.

The device of the invention operates as follows. The test gas is fed through the gas inlet 1 into the sensor. If the gas is oxygen-free and thus diamagnetic, it flows undisturbed through the field 3 of the magnet 4 and flows almost in its entirety through the wide main channel 6. Only a small amount of gas flows through the narrow measuring channel 7 and the reference channel 5 arranged in a symmetrical, mirror-image manner thereto. The small flows in these channels are beneficial to the sensitivity that can be obtained when measuring oxygen-containing gases. They constitute the core of the invention. The test gas exits the sensor through the gas outlet 7. An oxygen-containing gas is deflected in the magnetic field 3 of the magnet 4 towards the magnet 4. This change in direction causes the gas flow in the measuring channel 7 to increase; at the same time, it falls in the reference channel 5. These two flow rates are measured with the thermoanemometers 8; they correlate with the oxygen content of the gas. For precise measurement, the thermoelements in the reference channel 5 and in the measuring channel 7 are preferably connected up to a Wheatstone bridge circuit. The output signal from the bridge thus acts as a temperature-independent and pressure-independent measurement signal.

To increase the measurement sensitivity further, the magnetic susceptibility of the oxygen can be modulated by a heating device 2. Thin walls in the silicon structures thermally decouple the sensor from the surroundings.

1. A device for determining the oxygen content of a gas, comprising a gas inlet, a gas outlet and a measuring zone arranged therebetween, characterized in that the measuring zone comprises three channels arranged side by side in the form of a main channel, a measuring channel arranged on one side of the main channel and a reference channel arranged on the other side of the main channel, a magnet arranged on the side of the measuring channel opposite to the main channel and having a non-homogeneous magnetic field, and flow sensors in the measuring channel and reference channel.

2. The device according to claim 1, characterized in that a further flow sensor is arranged in the main channel.

3. The device according to claim 1, characterized in that the flow sensors are constructed as resistance thermometers.

4. The device according to claim 1, characterized in that the measuring zone comprising the flow sensors is produced using microsystem technology.

5. The device according to claim 1, characterized in that the measuring zone is constructed as a glass-silicon-glass stack.

6. The device according to claim 1, characterized in that it is at least partially made of polymers.

7. The device according to claim 3, characterized in that the resistance thermometers are thin film platinum thermometers.

8. The device according to claim 7, characterized in that the thin film platinum thermometers are undercut.

9. The device according to claim 7, characterized in that the thin film platinum thermometers are arranged at mid-height and in the centre of the channels.

10. The device according to claim 3, characterized in that the resistance thermometers are connected to a measuring bridge.

11. The device according to claim 1, characterized in that the magnet is a permanent magnet.

12. The device according to claim 11, characterized in that the permanent magnet is formed from rare-earth elements.

13. The device according to claim 1, characterized in that the magnet is an electromagnet.

14. The device according to claim 13, characterized in that it comprises a circuit for modulating the energizing current for the electromagnet.

15. The device according to claim 1, characterized in that a heating device is arranged between the gas inlet and the measuring zone for thermal modulation of the paramagnetic properties of the gas.
